(19) United States
(12) Patent Application Publication
(10) Pub. No.: US 2008/0266510 A1
(43) Pub. Date: Oct. 30, 2008

(54) Liquid crystal display device

(75) Inventors: Toshiaki Yoshihara, Kawasaki (JP); Tetsuya Makino, Kakogawa (JP); Shinji Tadaki, Kawasaki (JP); Hironori Shiroto, Kobe (JP); Yoshinori Kiyota, Kawasaki (JP); Keiichi Betsui, Yokohama (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/074,878

(22) Filed: Mar. 6, 2008

Related U.S. Application Data
(63) Continuation of application No. PCT/JP2005/016649, filed on Sep. 9, 2005.

(51) Int. Cl. G02F 1/1339

(52) U.S. Cl. 349/153

(57) ABSTRACT

In a liquid crystal display device which has a pair of opposing substrates having a gap filled with a liquid crystal material, with a peripheral edge portion of the paired substrates being sealed by a sealing member, between the thickness (tₛ) of the sealing member and the thickness (t_{lc}) of the liquid crystal layer, a relationship of tₛ/t_{lc}≧2, more preferably, tₛ/t_{lc}≧3, is satisfied. By making a difference smaller between a volume change in the liquid crystal material due to a temperature change and a volume change in a space in which the liquid crystal is sealed, defects caused by the volume difference are restrained from occurring. In order to achieve the relationship between tₛ and t_{lc}, a flat layer is placed on one or both of the substrates.

This application is Continuation Application under 35 U.S.C.§ 111(a) of PCT International Application No. PCT/JP2005/016649 which has an international filing date of Sep. 9, 2005 and designated the United State of America.

### BACKGROUND

1. Technical Field

The present invention relates to a liquid crystal display device, and more particularly, concerns a liquid crystal display device in which a space formed by sealing a peripheral edge portion of a pair of opposing substrates by a sealing member is filled with a liquid crystal material.

2. Description of Related Art

In recent years, together with developments of a so-called information society, electronic apparatuses, typically represented by personal computers, PDAs (Personal Digital Assistants) and the like, have been widely used. By the spread of these electronic apparatuses, there have been strong demands for portable apparatuses that can be used both in offices and outdoors, and small-size and light-weight apparatuses have also been demanded. As one of the means for achieving such demands, liquid crystal display devices have been widely used. The liquid crystal display device not only achieves a small-size, light-weight device, but also provides an indispensable technique for use in reducing the power consumption of a portable electronic apparatus that is driven by a battery.

Liquid crystal display devices are mainly classified into those of a reflecting type and those of a transmitting type. The device of a reflecting type has a structure in which light rays made incident on the front face of a liquid crystal panel are reflected by the back face of the liquid crystal panel so that images are visualized by the reflected light, and that of a transmitting type has a structure in which transmitted light from a light source (backlight) attached to the back face of a liquid crystal panel is used so that images are visualized. That of a reflecting type is unstable in its reflected light quantity depending on environmental conditions, and poor in visibility; therefore, in particular, as a display device for a personal computer or the like on which a multicolor or full color displaying process is performed, a transmitting type color liquid crystal display device using color filters has been generally used.

At present, color liquid crystal display devices of an active matrix type using switching elements, such as TFTs (Thin Film Transistors), have been widely used. Although these TFT-drive liquid crystal display devices have a high display quality, the light transmittance of the liquid crystal panel is in a low level of about several percents at present; consequently, a high luminance backlight is required to obtain high screen luminance. For this reason, the power consumption by the backlight becomes greater. Moreover, since a color displaying process is performed by using color filters, one pixel needs to be configured by three sub-pixels, and consequently, it becomes difficult to form a high-precision device and the display color purity is not sufficient.

In order to solve these problems, the inventors, etc. of the present invention have developed a liquid crystal display device of a field-sequential system (for example, see Non-patent Document 1, Non-patent Document 2 and Non-patent Document 3). In comparison with a liquid crystal display device of a color filter system, since this liquid crystal display device of the field-sequential system requires no sub-pixels, it becomes possible to easily achieve a displaying process with higher precision, and since a light emission color of a light source, as it is, can be utilized for a displaying process without using color filters, it is possible to achieve superior display color purity. Another advantage thereof is that since the light utilization efficiency is high, the power consumption can be reduced. However, in order to achieve a liquid crystal display of the field-sequential system, it is essential to provide a high-speed response (2 ms or less) of liquid crystal.

Therefore, in an attempt to provide a liquid crystal display device of the field-sequential system having the above-mentioned advantages or achieve a high-speed response of a liquid crystal display device of the color filter system, the inventors, etc. of the present invention have studied and developed a driving technique in which a switching element, such as a TFT of liquid crystal, like ferroelectric liquid crystal, having spontaneous polarization, is used and by which a high-speed response of 100 to 1000 times faster than that of a conventional device can be expected (for example, see Patent Document 1). In the ferroelectric liquid crystal, the major axis direction of a liquid crystal molecule is tilted by a voltage application. Liquid crystal panels sandwiching the ferroelectric liquid crystal are sandwiched by two polarizer plates having polarizing axes orthogonal to each other, and by utilizing birefringence caused by a change in the major axis direction of a liquid crystal molecule, the transmitted light intensity is changed.

[Patent Document 1] Japanese Patent Application Laid-Open No. H11-119189
[Non-patent Document 1] ILCC98, P1-074, issued in 1998 (T. Yoshihara, et al.)
[Non-patent Document 2] AM-LCD'99 Digest of Technical Papers, Page 185, issued in 1999 (T. Yoshihara, et al.)
[Non-patent Document 3] SID'00 Digest of Technical Papers, Page 1176, issued in 2000 (T. Yoshihara, et al.)

### SUMMARY

The ferroelectric liquid crystal having spontaneous polarization has a problem in that the alignment thereof is easily deformed by an external force and is hardly recovered. In order to solve this problem, a structure is prepared in which a sealing member made from a synthetic resin is placed on a peripheral edge portion of a pair of opposing substrates, with a space surrounded by the sealing member being filled with a liquid crystal material, so that the gap between the paired substrates is prevented from changing by an external force. In the case when a sealing member is placed in the liquid crystal panel, a problem arises in which due to a difference in linear expansion coefficients between the liquid crystal material and the sealing member, the change in the panel volume fails to follow the change in the volume of the liquid crystal material (in particular, contraction) to cause a disturbance in the liquid crystal alignment, resulting in defects in the liquid crystal layer. In particular, these alignment defects tend to occur near the peripheral sealed portion. Since the alignment defects are caused by the fact that the linear expansion coefficient of the sealing member is smaller than the linear expansion coefficient of the liquid crystal material, an attempt has been made conventionally so as to make the physical properties (in particular, linear expansion coefficient) of the sealing member coincident with the physical properties of the liquid crystal material; however, this attempt has not achieved sufficient effects.

Here, the occurrence of defects due to the difference between the volume change in the liquid crystal and the volume change in the space in which the liquid crystal is sealed is a problem that might commonly occur not only in the ferroelectric liquid crystal, but also in antiferroelectric liquid crystal having spontaneous polarization as well as in a liquid crystal material having no spontaneous polarization, for example, nematic liquid crystal. Here, in comparison with a liquid crystal material having no spontaneous polarization, the liquid crystal material having spontaneous polarization is more easily susceptible to defects to cause a more serious problem.

An object is to provide a liquid crystal display device that causes no defects even in a wider temperature range.

### Means for Solving the Problems

A liquid crystal display device according to an aspect is provided with a pair of opposing substrates having a gap filled with a liquid crystal material and a sealing member that seals a peripheral edge portion of the paired substrates, and in this structure, supposing that the thickness of the sealing member is tₛ and that the thickness of the liquid crystal layer is t_{lc}, a relationship of tₛ/t_{lc}≧2 is satisfied.

In the liquid crystal display device of the aspect, since, in general, the linear expansion coefficient of liquid crystal is greater than the linear expansion coefficient of a sealing member, by making the thickness of the sealing member two times thicker than the thickness of the liquid crystal material, the difference between the volume change in the liquid crystal material due to a temperature change and the volume change in the space in which liquid crystal is sealed is made smaller so that the occurrence of defects due to the volume difference is restrained.

Since the thickness of the sealing member is made two times, more preferably, three times, thicker than the thickness of the liquid crystal material, a difference between a volume change in liquid crystal and a volume change in a space in which liquid crystal is sealed, due to a temperature change, can be made smaller so that it becomes possible to provide a liquid crystal display device that causes no defects even in a wide temperature range.

### BRIEF DESCRIPTION OF THE SEVERAL VIEWS OF THE DRAWINGS

FIG. 1 is schematic cross-sectional view showing a liquid crystal panel and a backlight according to a first embodiment of a liquid crystal display device of a field-sequential system;

FIG. 2 is a schematic view showing an example of the entire structure of the liquid crystal display device;

FIG. 3 is a block diagram showing a circuit structure of the liquid crystal display device;

FIG. 4 is a schematic view showing an example of a structure of an LED array;

FIG. 5 shows one example of a driving sequence in a liquid crystal display device of the field-sequential system;

FIG. 6 is a schematic cross-sectional view showing a liquid crystal panel and a backlight according to a second embodiment of a liquid crystal display device of a field-sequential system;

FIG. 7 shows a graph that indicates a relationship between tₛ/t_{lc} and a defect length;

FIG. 8 is schematic cross-sectional view showing a liquid crystal panel and a backlight in a liquid crystal display device of a color filter system; and

FIG. 9 shows one example of a driving sequence in a liquid crystal display device of the color filter system.

### DESCRIPTION OF THE NUMERALS

2, 4: Glass substrate;
13: Liquid crystal layer;
15, 17: Flat layer;
16: Sealing member;
21: Liquid crystal panel; and
41: TFT.

### DETAILED DESCRIPTION

With reference to the drawings, embodiments will be discussed specifically.

### Embodiment 1

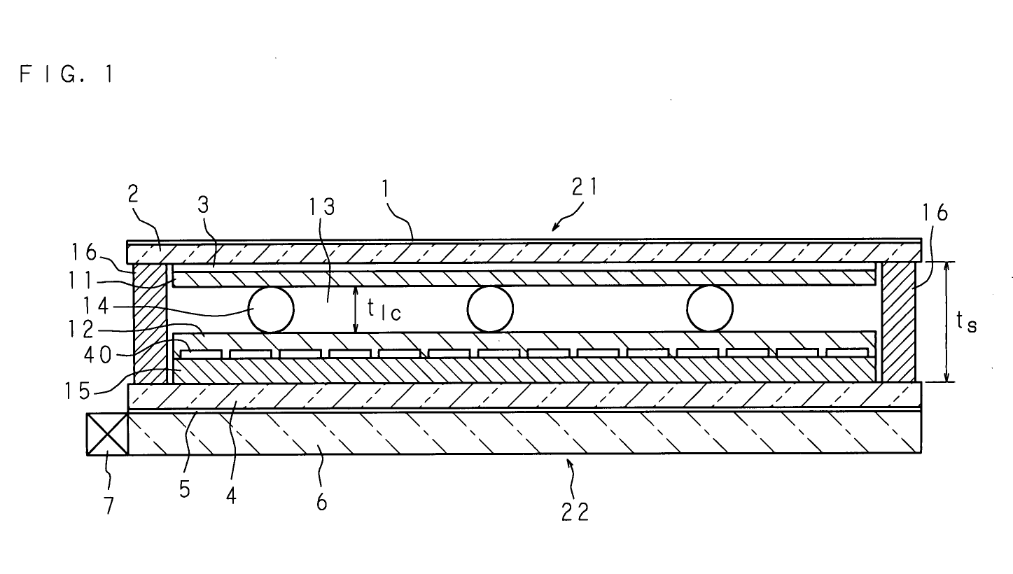

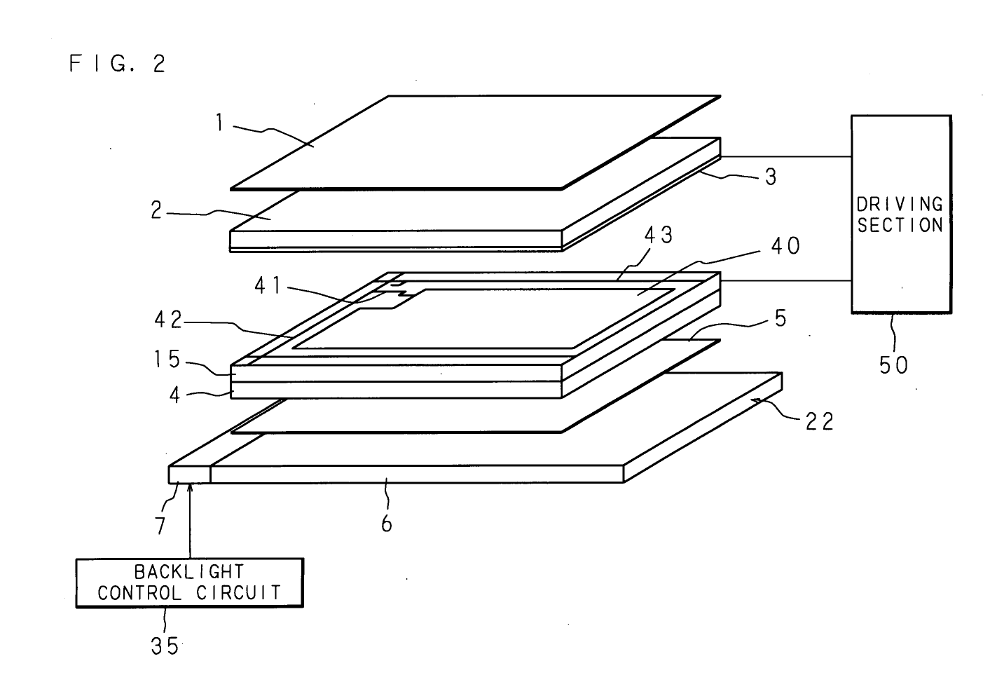

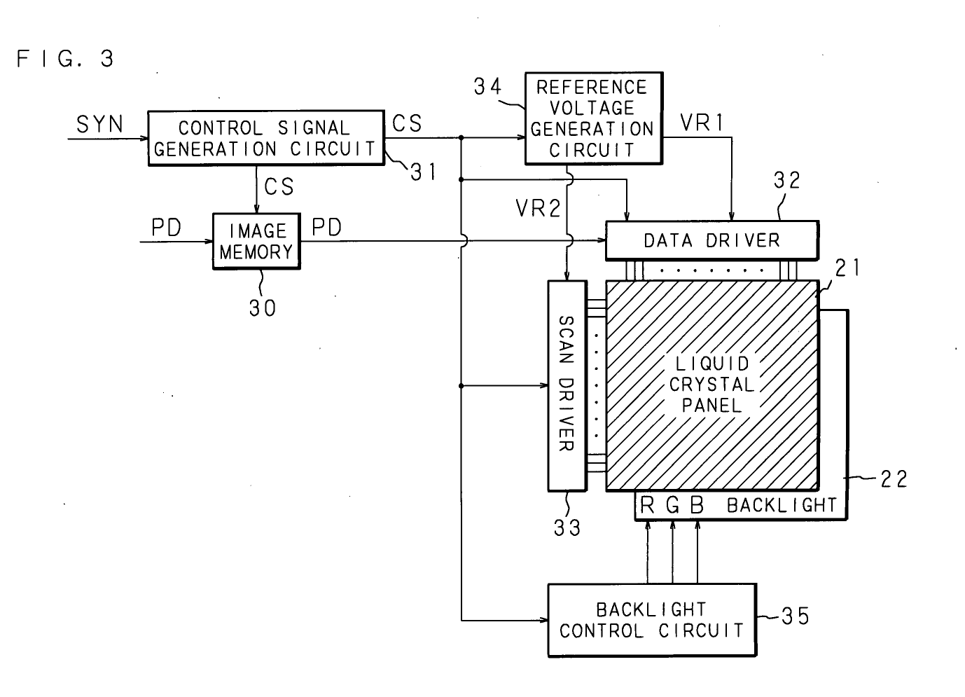

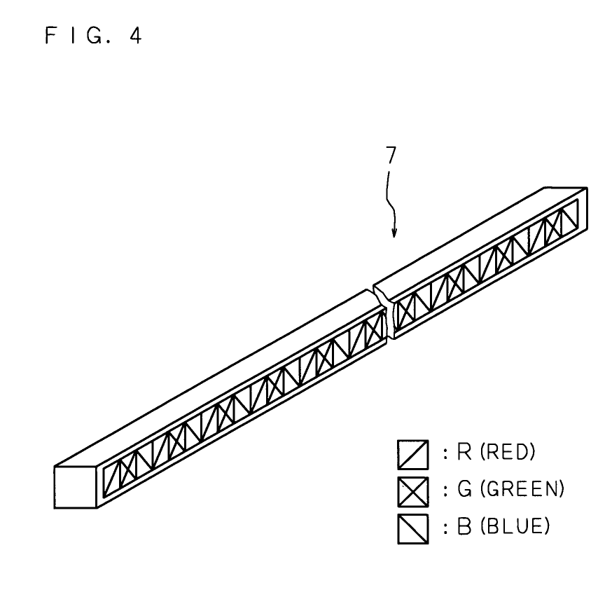

FIG. 1 is a schematic cross-sectional view showing a liquid crystal panel and a backlight according to a first embodiment of a liquid crystal display device. FIG. 2 is a schematic view showing an example of the entire structure of the liquid crystal display device. FIG. 3 is a block diagram showing a circuit structure of the liquid crystal display device. FIG. 4 is a schematic view showing an example of a structure of an LED (Light Emitting Diode) array serving as a light source for the backlight.

Reference numerals 21 and 22 indicate a liquid crystal panel and a backlight whose cross-sectional structures are shown in FIG. 1. As shown in FIGS. 1 and 2, the backlight 22 is configured by an LED array 7 and a light directing and diffusing plate 6. As shown in FIGS. 1 and 2, the liquid crystal panel 21 has a structure in which a polarizer 1, a glass substrate 2, a common electrode 3, a glass substrate 4 and a polarizer 5 are stacked in this order from the upper layer (surface) side to the back layer (back face) side, and pixel electrodes 40, 40 . . . , arranged in matrix, are formed on the surface of the glass substrate 4 on the common electrode 3 side through an acrylic flat layer 15.

An alignment film 12 is disposed on the upper face of the pixel electrodes 40, 40 . . . on the glass substrate 4, and an alignment film 11 is disposed on the lower face of the common electrode 3, respectively. Sealing members 16 made from epoxy resin are formed on peripheral edge portions of the glass substrate 2 and the glass substrate 4 that face each other. Here, a liquid crystal material having spontaneous polarization is filled in a space that is sandwiched by the alignment films 11 and 12, and sealed by the sealing member 16 so that a liquid crystal layer 13 is formed. Here, reference numeral 14 represents a spacer used for maintaining a layer thickness of the liquid crystal layer 13.

The flat layer 15 is placed between the glass substrate 4 and the pixel electrodes 40, 40 . . . in the center area of the glass substrate 4 with no sealing member 16 placed therein. The flat layer 15 adjusts the distance between the glass substrate 2 and the glass substrate 4. Thus, the thickness of the sealing member 16 is adjusted. The liquid crystal panel of the present embodiment satisfies a relationship of tₛ/t_{lc}≧2, more preferably, a relationship of tₛ/t_{lc}≧3, where the thickness of the sealing member 16 is set to tₛ and the thickness of the liquid crystal layer 13 is set to t_{lc}.

A driving section 50, configured by a data driver 32, a scan driver 33, etc., is connected between the common electrode 3 and the pixel electrodes 40, 40 . . . . The data driver 32 is connected to a TFT 41 through a signal line 42, and the scan driver 33 is connected to the TFT 41 through a scanning line 43. The TFT 41 is on/off controlled by the scan driver 33. Here, the individual pixel electrodes 40, 40 . . . are connected to the TFT 41. For this reason, the transmitted light intensity of each of the pixels is controlled by the signal from the data driver 32 given through the signal line 42 and the TFT 41.

The backlight 22, which is placed on the lower layer (back face) side of the liquid crystal panel 21, is provided with the LED array 7 that is allowed to face the end face of a light directing and diffusing plate 6 forming a light-emitting area. The LED array 7 whose schematic drawing is given in FIG. 4 is provided with a plurality of LEDs that are placed on a face opposing the light directing and light diffusing plate 6, with LED elements emitting light rays of respective three primary colors, that is, red (R), green (G) and blue (B), being set as one chip. Here, the respective LED elements of red, green and blue are respectively turned on in the respective sub-frames of red, green and blue. The light directing and diffusing plate 6 directs light rays from the respective LEDs of the LED array 7 to its entire surface and diffuses them toward the upper surface so that it serves as a light-emitting area. Since the LEDs are used as a light source for display, switching between turning on and off can be easily carried out, and divided turning on and off of the backlight 22 can also be easily carried out.

This liquid crystal panel 21 is superposed on the backlight 22 capable of carrying out time-division light emissions of red, green and blue. The lighting on/off timing and light emission color of the backlight 22 are controlled in synchronism with a data writing scanning process of the liquid crystal panel 21 based upon display data.

In FIG. 3, reference numeral 31 represents a control signal generation circuit that generates various control signals CS required for display in response to a synchronous signal SYN inputted from a personal computer. Pixel data PD is outputted to a data driver 32 from an image memory 30. Based upon the pixel data PD and the control signals CS used for changing the polarity of an applied voltage, a voltage is applied to the liquid crystal panel 21 through the data driver 32.

Moreover, control signals CS are respectively outputted from the control signal generation circuit 31 to a reference voltage generation circuit 34, a data driver 32, a scan driver 33 and a backlight control circuit 35. The reference voltage generation circuit 34 generates reference voltages VR1 and VR2, and outputs the generated reference voltage VR1 to the data driver 32, as well as outputting the generated reference voltage VR2 to the scan driver 33. Based upon the pixel data PD from the image memory 30 and the control signals CS from the control signal generation circuit 31, the data driver 32 outputs a signal to a signal line 42 of a pixel electrode 40. In synchronism with the output of this signal, the can driver 33 sequentially scans scanning lines 43 of the pixel electrodes 40 for each line. Moreover, the backlight control circuit 35 supplies a driving voltage to the backlight 22 so as to allow the backlight 22 to emit red, green and blue light rays respectively.

In accordance with the output of a signal from the data driver 32 and the scanning of the scan driver 33, the TFT 41 is driven so that a voltage is applied to the pixel electrode 40 to control the transmittance of the pixel. Upon receipt of the control signal CS, the backlight control circuit 35 applies a driving voltage to the backlight 22 so that the LED elements of the respective colors of red, green and blue possessed by the LED array 7 of the backlight 22 are allowed to emit light rays in a time-division manner; thus, red, green and blue light rays are emitted sequentially with time. In this manner, lighting on/off controls of the respective colors of the backlight 22 and the data writing scanning process on the liquid crystal panel 21 are synchronized with each other to carry out a color displaying process in the field-sequential system.

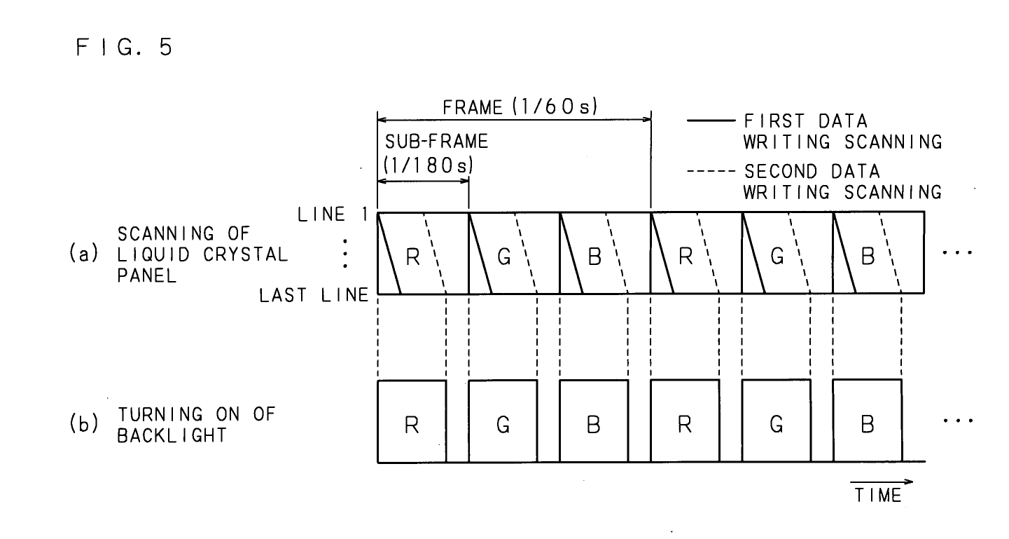

FIG. 5 shows one example of a driving sequence in the field-sequential system. FIG. 5(a) indicates scanning timing of the respective lines of the liquid crystal panel 21, and FIG. 5(b) indicates light on/off timing of the respective colors of red, green and blue of the backlight 22.

One frame (period: 1/60 s) is divided into three sub-frames (period: 1/180 s), with the frame frequency being set to 60 Hz, and as shown in FIG. 5(a), in one frame, writing scanning processes for image data of red color are carried out on the first sub-frame two times, writing scanning processes for image data of green color are carried out on the next second sub-frame two times, and writing scanning processes for image data of blue color are carried out on the last third sub-frame two times.

Here, in each of the sub-frames of red color, green color and blue color, a voltage having a polarity that provides a light display image according to display data is applied to the liquid crystal of each pixel through a switching process of the TFT 41, during the first (front half) data writing scanning process. During the second (latter half) data writing scanning process, based upon the same display data as those of the first data writing scanning process, a voltage that has the same size, with a polarity different from that of the first data writing scanning process, is applied to the liquid crystal of each pixel so that dark display that is virtually regarded as black display in comparison with that of the first data writing scanning process is obtained.

As shown in FIG. 5(b), in the lighting on/off controls of the respective colors of red, green and blue of the backlight 22, the red color is light-emitted in the first sub-frame, the green color is light-emitted in the second sub-frame, and the blue color is light-emitted in the third sub-frame. Here, the backlight 22 is not kept turning on all through the sub-frames, and in synchronism with the start timing of the first data writing scanning process, the backlight 22 is turned on, while the backlight 22 is turned off in synchronism with the end timing of the second data writing scanning process.

### Embodiment 2

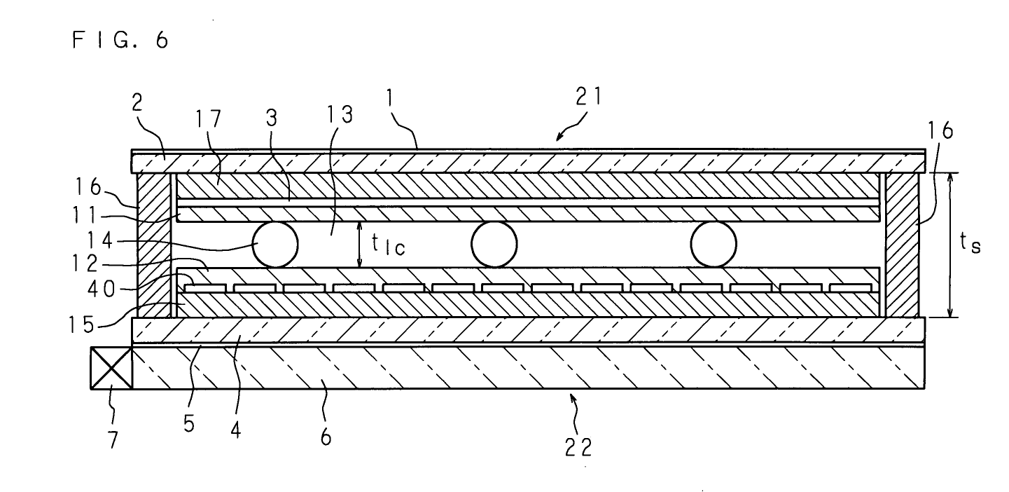

FIG. 6 is a schematic cross-sectional view showing a liquid crystal panel and a backlight according to a second embodiment of a liquid crystal display device. In FIG. 6, those parts that are the same as those shown in FIG. 1 are indicated by the same reference numerals, and the description thereof is omitted.

In the second embodiment shown in FIG. 6, as well as a flat layer 15 on the glass substrate 4, a flat layer 17 is also placed between the glass substrate 2 and the common electrode 3. With this arrangement, the thickness of the sealing member 16 is adjusted. Thus, the liquid crystal panel of the present embodiment makes it possible to satisfy the relationship of tₛ/t_{lc}≧2, more preferably, tₛ/t_{lc}≧3.

In the liquid crystal display having the structure as shown in FIG. 6 also, the same display driving control as that of the aforementioned liquid crystal display device shown in FIG. 1 is of course carried out.

Although not shown in the Figures, only the flat layer 17 may be placed between the glass substrate 2 and the common electrode 3, without placing the flat layer 15. Such a structure also makes it possible to satisfy the relationship of tₛ/t_{lc}≧2, more preferably, tₛ/t_{lc}≧3.

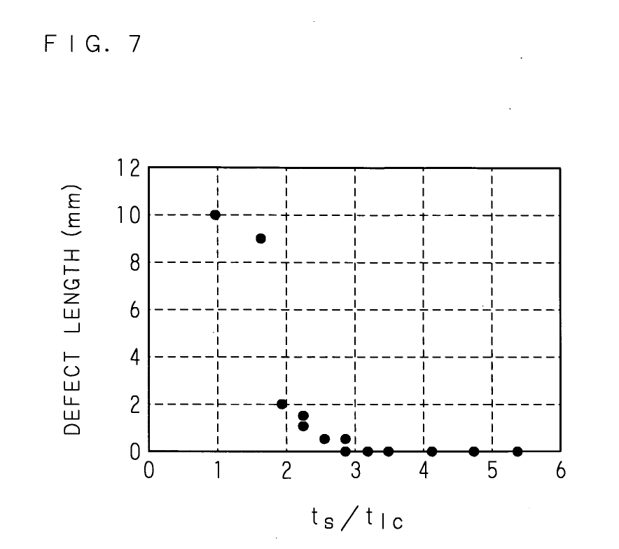

The following description will discuss the range of tₛ/t_{lc}, which forms the feature of the present embodiment. FIG. 7 is a graph that indicates a relationship between tₛ/t_{lc} and a defect length near the sealing member 16, in the case when a ferroelectric liquid crystal is used as the liquid crystal material.

The linear expansion coefficient in the chiral smectic C phase of the applied ferroelectric liquid crystal material is about 690 ppm, and the linear expansion coefficient of the sealing member 16 is about 140 ppm. The ferroelectric liquid crystal is heated to a nematic phase, and after having been injected into the panel, this is cooled to room temperature; thus, by observing this in a chiral smectic phase, the defect length was measured. By placing the acrylic flat layers 15 and 17 on one or both of the glass substrate 2 and the glass substrate 4 (see FIGS. 1 and 6), the thickness tₛ of the sealing member 16 is adjusted.

The graph of FIG. 7 indicates that by increasing the value of tₛ/t_{lc}, the defect length can be suppressed. This suppressing effect becomes conspicuous when the value of tₛ/t_{lc} becomes 2 or more, and hardly any defect occurs when the value of tₛ/t_{lc} becomes 3 or more. Based upon these facts, it is found that by satisfying the relationship of tₛ/t_{lc}≧2, more preferably, tₛ/t_{lc}≧3, the occurrence of defects can be suppressed.

### Example 1

A glass substrate 4 on which pixel electrodes 40, 40 . . . (number of pixels: 640×480, length across corners: 3.2 inches) were placed with a flat layer 15 made of an acrylic material with a thickness of 2 μm being interposed therebetween and a glass substrate 2 having a common electrode 3 were washed, and these were then coated with polyimide and baked at 200° C. for one hour so that polyimide films of about 200 Å were formed as alignment films 11 and 12. Moreover, these alignment films 11 and 12 were rubbed with a cloth made from rayon, and these two substrates were superposed one on the other, with the rubbing directions being made in parallel with each other, with a gap being maintained therein by using a sealing member 16 that is made from an epoxy resin and placed on a peripheral edge portion and spacers 14 made of silica having an average particle size of 1.6 μm; thus, empty panels with a gap maintained therein were manufactured.

A ferroelectric liquid crystal material of a bistable type, mainly composed of a naphthalene-based liquid crystal (for example, a material disclosed by A. Mochizuki, et. al.: Ferroelectrics, 133, 353 (1991)), was injected into the empty panels to be sealed therein so that a liquid crystal layer 13 was formed. The intensity of spontaneous polarization of the ferroelectric liquid crystal material thus sealed was 6 nC/cm². The panels thus manufactured were formed into a liquid crystal panel 21 with two polarizers 1 and 5 in a cross-nichol state being interposed therebetween so that a dark state was prepared when the major axis direction of the ferroelectric liquid crystal molecule was tilted in one direction.

In Example 1, the thickness t_{lc} of the liquid crystal material (liquid crystal layer 13) was 1.6 μm corresponding to the thickness of the spacer 14, and the thickness tₛ of the sealing member 16 was 1.6+2=3.6 μm obtained by adding the thickness of the flat layer 15 to the thickness of the spacer 14; thus, tₛ/t_{lc}=2.25. When the panel state after the liquid crystal injection was observed, no defects were observed within the display area although slight defects due to a volume change in the liquid crystal were observed outside the display area.

The liquid crystal panel 21 of Example 1 thus manufactured and the backlight 22 in which an LED array 7, made of twelve LEDs, with respective LED elements that emit light rays of respective colors of red (R), green (G) and blue (B) being formed into one chip, was used as a light source were superposed on each other, and a color displaying operation by the field-sequential system was carried out in accordance with a driving sequence as shown in FIG. 5. As a result, a high-precision, high-speed response and high color purity displaying operation was achieved without causing any defects within the display area.

### Comparative Example 1

The same liquid crystal panel as that of Example 1 except that no flat layer 15 was formed on the glass substrate 4 in comparison with Example 1 was manufactured.

In Comparative Example 1, since no flat layer was placed, each of the thickness t_{lc} of the liquid crystal material (liquid crystal layer) and the thickness of the sealing member tₛ was 1.6 μm corresponding to the thickness of the spacer, and tₛ/t_{lc}≈1. When the panel state after the liquid crystal injection was observed, defects due to a volume change in the liquid crystal were intruded into the display area.

The liquid crystal panel of Comparative Example 1 and the backlight 22 that is the same as that of Example 1 were superposed on each other, and a color displaying operation by the field-sequential system was carried out in accordance with the driving sequence as shown in FIG. 5. As a result, a high-precision, high-speed response and high color purity displaying operation was achieved; however, defects occurred within the display area.

### Example 2

A glass substrate 4 on which pixel electrodes 40, 40 . . . (number of pixels: 640×480, length across corners: 3.2 inches) were placed with a flat layer 15 made of an acrylic material with a thickness of 2 μm being interposed therebetween and a glass substrate 2 having a common electrode 3, with a flat layer 17 made of an acrylic material with a thickness of 2 μm being interposed therebetween, were washed, and these were then coated with polyimide and baked at 200° C. for one hour so that polyimide films of about 200 Å were formed as alignment films 11 and 12. Moreover, these alignment films 11 and 12 were rubbed with a cloth made from rayon, and these two substrates were superposed on one another, with the rubbing directions being made in parallel with each other, with a gap being maintained therein by using a sealing member 16 that is made from an epoxy resin and placed on a peripheral edge portion and spacers 14 made of silica having an average particle size of 1.6 μm; thus, empty panels were manufactured.

A ferroelectric liquid crystal material of a bistable type, mainly composed of a naphthalene-based liquid crystal (for example, a material disclosed by A. Mochizuki, et. al.: Ferroelectrics, 133, 353 (1991)), was injected into this empty panel to be sealed therein so that a liquid crystal layer 13 was formed. The intensity of spontaneous polarization of the ferroelectric liquid crystal material thus sealed was 6 nC/cm². The panels thus manufactured were formed into a liquid crystal panel 21 with two polarizers 1 and in a cross-nichol state being interposed therebetween so that a dark state was prepared when the major axis direction of the ferroelectric liquid crystal molecule was tilted in one direction.

In Example 2, the thickness t_{lc} of the liquid crystal material (liquid crystal layer 13) was 1.6 μm corresponding to the thickness of the spacer 14, and the thickness tₛ of the sealing member 16 was 1.6+2+2=5.6 μm obtained by adding the thicknesses of the two flat layer 15 and flat layer 17 to the thickness of the spacer 14; thus, tₛ/t_{lc}=3.5. When the panel state after the liquid crystal injection was observed, no defects due to a volume change in the liquid crystal, were observed within the display area as well as out of the display area. Moreover, even after the panel had been cooled to −40° C. and then returned to room temperature, no defects due to a volume change in the liquid crystal were observed within the display area as well as out of the display area.

The liquid crystal panel 21 of Example 2 thus manufactured and the backlight 22 that was the same as that of Example 1 were superposed on each other, and a color displaying operation by the field-sequential system was carried out in accordance with a driving sequence as shown in FIG. 5. As a result, a high-precision, high-speed response and high color purity displaying operation was achieved without causing any defects within the display area as well as out of the display area, in a wide temperature range.

### Example 3

A glass substrate 4 on which pixel electrodes 40, 40 . . . (number of pixels: 640×480, length across corners: 3.2 inches) were placed with a flat layer 15 made of an acrylic material with a thickness of 2 μm being interposed therebetween and a glass substrate 2 having a common electrode 3, with a flat layer 17 made of an acrylic material with a thickness of 2 μm being interposed therebetween, were washed, and these were then coated with polyimide and baked at 200° C. for one hour so that polyimide films of about 200 Å were formed as alignment films 11 and 12. Moreover, these alignment films 11 and 12 were rubbed with a cloth made from rayon, and these two substrates were superposed on each other, with the rubbing directions being made in parallel with each other, with a gap being maintained therein by using a sealing material 16 that is made from an epoxy resin and placed on a peripheral edge portion and spacers 14 made of silica having an average particle size of 1.6 μm; thus, empty panels were manufactured.

A ferroelectric liquid crystal material of a bistable type (for example, R2301 made by Clariant in Japan) was sealed in these empty panels so that a liquid crystal layer 13 was formed. The intensity of spontaneous polarization of the ferroelectric liquid crystal material thus sealed was 6 nC/cm². After the liquid crystal material had been sealed in the panel, by applying a voltage of 10V thereto within a temperature range with the transition point from a cholesteric phase to a chiral smectic C phase being sandwiched therein, a uniform liquid crystal alignment state was achieved. The panels thus manufactured were formed into a liquid crystal panel 21, with two polarizers 1 and 5 in a cross-nichol state being interposed therebetween, so that a dark state was prepared at the time when no voltage was applied.

In Example 3, in the same manner as in Example 2, the thickness t_{lc} of the liquid crystal material (liquid crystal layer 13) was 1.6 μm, and the thickness tₛ of the sealing member 16 was 5.6 μm so that tₛ/t_{lc}=3.5. When the panel state after the liquid crystal injection was observed, no defects due to a volume change in the crystal display were observed within the display area as well as out of the display area. Moreover, even after the panel had been cooled to −40° C. and then returned to room temperature, no defects due to a volume change in the liquid crystal were observed within the display area as well as out of the display area.

The liquid crystal panel 21 of Example 3 thus manufactured and the backlight 22 that was the same as that of Example 1 were superposed on each other, and a color displaying operation by the field-sequential system was carried out in accordance with a driving sequence as shown in FIG. 5. As a result, a high-precision, high-speed response and high color purity displaying operation was achieved without causing any defects within the display area as well as out of the display area, in a wide temperature range.

The above-mentioned embodiments have been explained by exemplifying a liquid crystal display device of the field-sequential system; however, the same effects can also be obtained in a liquid crystal display device of a color-filter system having a color filter.

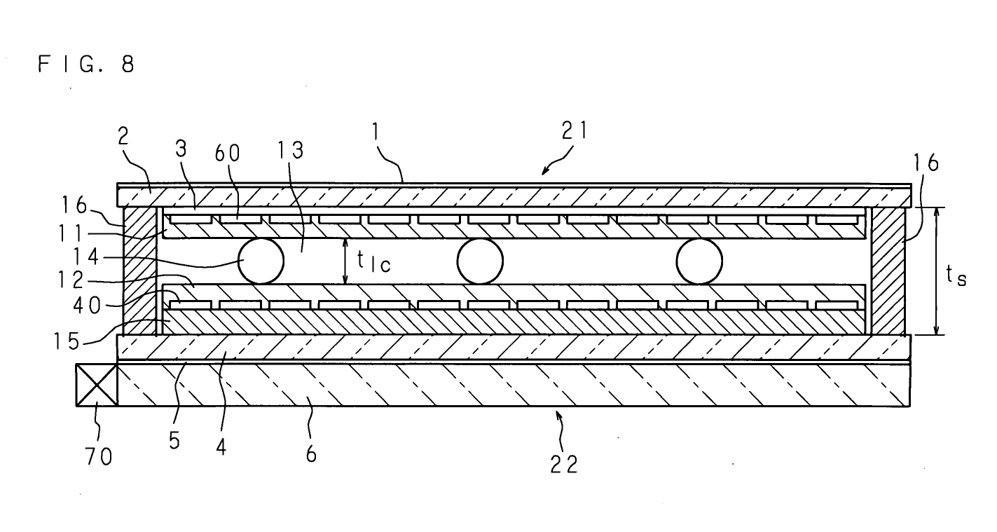

FIG. 8 is schematic cross-sectional view showing a liquid crystal panel and a backlight in a liquid crystal display device of a color filter system. In FIG. 8, those parts that are the same as those shown in FIG. 1 are indicated by the same reference numerals, and the description thereof is omitted. Color filters 60, 60 . . . of three primary colors (R, G and B) are placed on the common electrode 3. Moreover, the backlight 22 is configured by a white light source 70 provided with a plurality of white light-source elements that emit white light and a light directing and diffusing plate 6. In such a liquid crystal display device of a color filter system, white light from the white light source 70 is selectively transmitted by color filters 60 having a plurality of colors so that a color displaying process is carried out.

In the embodiment shown in FIG. 8 also, between the thickness (tic) of the liquid crystal layer 13 and the thickness (tₛ) of the sealing member 16, a relationship of tₛ/t_{lc}≧2, more preferably, tₛ/t_{lc}≧3, is satisfied. The example of FIG. 8 has a structure in which a flat layer 15 is placed between the glass substrate 4 and the pixel electrodes 40, 40 . . . ; however, a flat layer 17 may be placed between the glass substrate 2 and the common electrode 3, and in the same manner as in the second embodiment shown in FIG. 6, a structure may be used in which the flat layer 15 and the flat layer 17 are placed on the glass substrate 4 and the glass substrate 2 respectively.

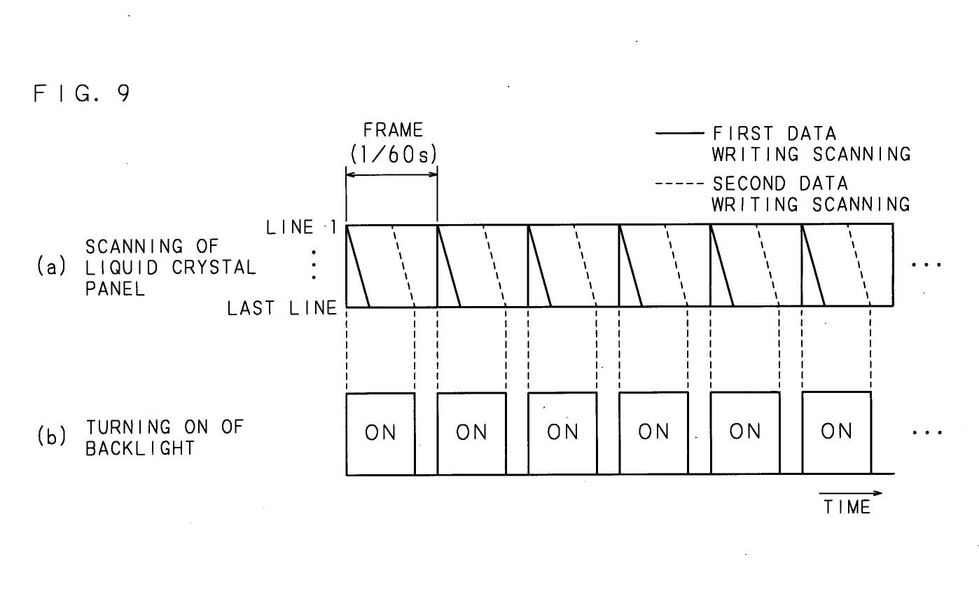

Here, by performing a color displaying process in accordance with the driving sequence shown in FIG. 9, a superior displaying process can be achieved without causing defects in the display area in the same manner as in a liquid crystal display device of the field-sequential system, even when a liquid crystal display device of the color filter system is used.

The above-mentioned embodiments have been explained by exemplifying a structure using a ferroelectric liquid crystal material having spontaneous polarization; however, other liquid crystal materials having spontaneous polarization, for example, an antiferroelectric liquid crystal material may be used, or a nematic liquid crystal material having no spontaneous polarization may be used, and the same effects are obtained. Moreover, not limited to the liquid crystal display device of a transmission type, the present embodiments may be applied to a liquid crystal display device of a reflection type and a front/rear projector.

In an embodiment of the liquid crystal display device, between the thickness (tₛ) of the sealing member and the thickness (t_{lc}) of the liquid crystal material, the relationship of tₛ/t_{lc}≧3 is satisfied. By making the thickness of the sealing member three times larger than the thickness of the liquid crystal material, the effect of restraining the occurrence of defects is further enhanced.

In an embodiment of the liquid crystal display device, the flat layer is formed in an area except for the peripheral edge sealed portion of one of the substrates so as to properly increase the thickness. By placing the flat layer, the thickness of the sealing member on the peripheral edge portion can be easily adjusted.

In an embodiment of the liquid crystal display device, the flat layer is formed in an area except for the peripheral edge sealed portion of each of the two substrates so as to properly increase the thickness. By placing the flat layer, the thickness of the sealing member on the peripheral edge portion can be precisely adjusted more easily.

In an embodiment of the liquid crystal display device, a switching element for use in controlling an applied voltage to the liquid crystal material is placed in each of the pixels. Therefore, a voltage controlling process is easily carried out for each of the pixels so that a clearer displayed image is obtained in comparison with that of a liquid crystal display device of a simple matrix type with no switching elements.

In an embodiment of the liquid crystal device, a material having spontaneous polarization is used as the liquid crystal material. By using the liquid crystal material having spontaneous polarization, a high-speed response is available so that a high animation displaying property is achieved and a displaying process of a field-sequential system can be easily achieved.

In an embodiment of the liquid crystal device, since a ferroelectric liquid crystal having a small spontaneous polarization value is used as the liquid crystal material having spontaneous polarization, a driving process by using switching elements such as TFTs is easily achieved.

In an embodiment of the liquid crystal device, since a antiferroelectric liquid crystal material is used as the liquid crystal material having spontaneous polarization, a high-speed response is available so that a high animation displaying property is achieved and a displaying process of a field-sequential system can be easily achieved.

In an embodiment of the liquid crystal device, a color displaying process is performed in the field-sequential system in which light rays of a plurality of colors are switched with time. Therefore, it becomes possible to carry out a color displaying process with high-precision, high color purity and a high-speed response.

In an embodiment of the liquid crystal device, the color displaying process is performed in a color filter system using color filters. Therefore, it is possible to easily carry out a color displaying process.

What is claimed is:

1. A liquid crystal display device comprising:
a pair of substrates facing each other;
a liquid crystal material filled between the pair of the substrates; and
a sealing member placed at a periphery of the pair of the substrates, wherein
a relationship tₛ/t_{lc}≧2 is satisfied, where
tₛ is a thickness of the sealing member, and
t_{lc} is a thickness of the liquid crystal material.

2. The liquid crystal display device according to claim 1, wherein a relationship tₛ/t_{lc}≧3 is satisfied.

3. The liquid crystal display device according to claim 1, wherein a flat layer is placed in an area on one of the pair of the substrates where no sealing member is placed.

4. The liquid crystal display device according to claim 1, wherein a flat layer is placed at inside of the periphery of the one of the substrates where no sealing member is placed.

5. The liquid crystal display device according to claim 1, wherein a switching element used for controlling an applied voltage to the liquid crystal material is placed in association with each of a plurality of pixels.

6. The liquid crystal display device according to claim 1, wherein the liquid crystal material is a liquid crystal material having spontaneous polarization.

7. The liquid crystal display device according to claim 6, wherein the liquid crystal material is a ferroelectric liquid crystal material.

8. The liquid crystal display device according to claim 6, wherein the liquid crystal material is an antiferroelectric liquid crystal material.

9. The liquid crystal display device according to claim 1, wherein a color displaying process is performed in a field-sequential system.

10. The liquid crystal display device according to claim 1, wherein a color displaying process is performed in a color filter system.
